(19) United States
(12) Patent Application Publication
(10) Pub. No.: US 2014/0228589 A1
(43) Pub. Date: Aug. 14, 2014

(54) PROCESS FOR PRODUCING POWDERS FROM ALKALI METAL SALTS OF SILANOLS

(71) Applicants: Michael Stepp, Ueberackern (AT); Michael Mueller, Laufen (DE); Birgit Peschanel, Burghausen (DE)

(72) Inventors: Michael Stepp, Ueberackern (AT); Michael Mueller, Laufen (DE); Birgit Peschanel, Burghausen (DE)

(73) Assignee: WACKER CHEMIE AG, Munich (DE)

(21) Appl. No.: 14/345,779

(22) PCT Filed: Sep. 7, 2012
(86) PCT No.: PCT/EP2012/067462

§ 371 Date: Mar. 19, 2014

(30) Foreign Application Priority Data
Sep. 21, 2011 (DE) 10 2011 083 109.6

(51) Int. Cl. C07F 7/08

(52) U.S. Cl. CPC C07F 7/0836
USPC 556/463

(57) ABSTRACT

Alkali metal silanolates are prepared by a process in which alcohol and water are removed from an alkali metal silanolate hydrolysis mixture in two steps, the second removal step occurring at a pressure lower than the first removal step.

The invention relates to a process for producing powders (P) of silanol salts from alkoxysilanes, alkali metal hydroxide and water, in which water and alcohol are removed in two steps.

Alkali metal organosiliconates such as potassium methyl siliconate have already been in use for decades for hydrophobization, in particular of mineral construction materials. Owing to their good solubility in water they can be applied in the form of an aqueous solution to solids, where, after evaporation of the water, they form firmly adhering, permanently water-repellent surfaces under the influence of carbon dioxide. Since they comprise virtually no hydrolytically cleavable organic radicals, curing advantageously takes place without the release of undesirable volatile, organic secondary products.

The preparation of alkali metal organosiliconates, in particular potassium and sodium methyl siliconates, has been described many times. In most cases, the focus is on the preparation of ready-for-use and storage-stable, aqueous solutions. For example, DE 4336600 claims a continuous process starting from organotrichlorosilanes via the intermediate organotrialkoxysilane. Advantages of that process are that the secondary products hydrogen chloride and alcohol that form are recovered, and the siliconate solution that forms is virtually free of chlorine.

Ready-for-use construction material mixtures such as cement or gypsum renders and fillers or tile adhesives are mainly supplied to the construction site in the form of powders in bags or silos and are only mixed with the mixing water on site. There is required for that purpose a solid hydrophobizing agent which can be added to the ready-for-use dry mixture and develops its hydrophobizing action in a short time only upon addition of water during application on site, for example on the construction site. This is called dry-mix application. Organosiliconates in solid form have proved to be very efficient hydrophobizing additives for that purpose. Their use is described, for example, in the following specifications: Application PCT/EP2011/061766 claims solid organosiliconates having a reduced alkali metal content. Their preparation is carried out by hydrolysis of alkoxy- or halo-silanes with aqueous alkali metal hydroxide solution and azeotropic drying of the resulting, optionally alcoholic-aqueous siliconate solution with the aid of an inert solvent as entrainer.

U.S. Pat. No. 2,567,110 describes access to neutral (poly)siloxanes starting from alkali metal sil(ox)anolates and chlorosilanes. Example 1 describes the preparation of sodium methyl siliconate by reaction of a monomethylsiloxane hydrolyzate with a molar equivalent of sodium hydroxide solution in the presence of ethanol. The solid is isolated by distilling off the solvent and is then dried at 170° C. to a constant weight. Such a process for isolating solids is unworkable on an industrial scale because there form on the walls of the reaction vessel deposits that adhere firmly during the concentration by evaporation.

A further disadvantage of the hitherto described processes of concentration by evaporation in the isolation of the solid is the fact that alkali metal siliconates decompose thermally, which constitutes a reaction safety problem. For example, potassium methyl siliconate (K:Si=1:1) decomposes above 120° C. in a highly exothermic reaction of 643 J/g with the loss of the methyl group. Under adiabatic conditions, the temperature rises to over 300° C. Consequently, it is also to be assumed that thermal decomposition occurs in the process claimed in DE 1176137 for drying an aqueous siliconate solution at 350-400° C. on a rotating hotplate. Irrespective thereof, such high temperatures require specific, expensive materials and complex safety measures in particular when flammable solvents are present. Moreover, starting from predominantly or purely aqueous solutions of the alkali metal siliconates, a very large amount of energy is required for the evaporation of the solvent water, which impairs the economy of the process or is too complex in terms of apparatus for conversion to an industrial scale.

U.S. Pat. No. 2,438,055 describes the preparation of siliconates as hydrates in solid form. In that document, the hydrolyzate of a monoorganotrialkoxysilane or of a monoorganotrichlorosilane is reacted with 1-3 molar equivalents of alkali metal hydroxide in the presence of alcohol. The siliconates formed as hydrates are crystallized out by evaporating off the alcohol or by adding corresponding non-polar solvents. In Example 1, the preparation of solid sodium methyl siliconate hydrates is described: to that end, 1 molar equivalent of methyltriethoxy-silane is reacted with 1 molar equivalent of sodium hydroxide in the form of saturated sodium hydroxide solution (i.e. 50 wt. %). Methanol is added to the solution in order to crystallize the siliconate. Evidently only a portion of the siliconate thereby precipitates. In fact, a further solid is isolated by concentration of the mother liquor by evaporation, which solid exhibits a 21% weight loss upon drying over P₂O₅ at 140° C. Nothing is said about the relative proportions.

In U.S. Pat. No. 2,803,561 alkyltrichlorosilane is hydrolyzed to the corresponding alkylsilicic acid, which is subsequently reacted with alkali metal hydroxide to give an aqueous solution of alkali metal siliconate, which is stabilized by addition of up to 10% alcohol or ketone. How the drying of the siliconate is carried out is not described. The use of the dried siliconate for the hydrophobization of gypsum is mentioned.

The invention provides a process for producing powders (P) from salts of silanols, of their hydrolysis/condensation products, or of silanols together with their hydrolysis/condensation products and cations selected from alkali metal ions in which the molar ratio of cation to silicon is from 0.1 to 3, wherein in a first step alkoxysilanes, their hydrolysis/condensation products, or alkoxysilanes together with their hydrolysis/condensation products, wherein the alkoxy group is selected from methoxy, ethoxy, 1-propoxy and 2-propoxy group, are hydrolyzed with alkali metal hydroxide and water, in a second step at least a total of 20 percent by weight of the water and alcohol present in the hydrolyzate are distilled off from the hydrolyzate prepared in the first step, and in a third step residual water and alcohol are removed at a lower pressure than in the second step.

The process differs from the prior art by a stepwise drying process. In that process, the aqueous-alcoholic solutions of organosiliconates, the preparation of which is described, for example, in PCT/EP2011/061766 and DE 4336600, that are obtained in the hydrolysis reaction of alkoxysilanes with alkali metal hydroxide solutions are partially devolatilized at a pressure of preferably at least 800 hPa in the second step and are concentrated to dryness by evaporation under reduced pressure in the third step. Surprisingly, it is possible in this stepwise procedure to avoid the intermediate formation of a highly viscous, scarcely stirrable mass and hence agglomeration to larger solids particles which are difficult to break up, so that drying is possible quickly and gently in a simple stirring unit or paddle drier. The process is very energy efficient and environmentally friendly because no azeotropic solvent is required and only the minimal required amount of water must be evaporated off. The distillates contain only alcohol and water and thus permit simple recycling of reusable materials.

In order for the process to be carried out, it is a precondition that the alcohol present in the hydrolyzate has a lower boiling point than water, that is to say is selected from methanol, ethanol, 1-propanol or 2-propanol.

Salts of organosilanols are preferably prepared in the process, there being used in the first step organoalkoxysilanes of the general formula 1

(R¹)ₐSi(OR⁴)_{b}(−Si(R²)_{3-c}(OR⁴)_{c})_{d} (1)

or their hydrolysis/condensation products, or the organosilanes of the general formula 1 together with their hydrolysis/condensation products, wherein
R¹, R² represent a monovalent Si—C-bonded hydrocarbon radical having from 1 to 30 carbon atoms which is unsubstituted or substituted by halogen atoms, amino groups, C₁₋₆-alkyl or C₁₋₆-alkoxy or silyl groups and in which one or more non-adjacent —CH₂— units can be replaced by groups —O—, —S— or —NR³— and in which one or more non-adjacent ═CH— units can be replaced by groups —N═,
R³ represents hydrogen, a monovalent hydrocarbon radical having from 1 to 8 carbon atoms which is unsubstituted or substituted by halogen atoms or NH₂ groups,
R⁴ represents methoxy, ethoxy, 1-propoxy or 2-propoxy group,
a represents the values 1, 2 or 3, and
b, c, d represent the values 0, 1, 2 or 3,
with the proviso that b+c≧1 and a+b+d=4.

In the first step of the process there can also be used mixed oligomers of compounds of the general formula 1, or mixtures of those mixed oligomeric siloxanes with monomeric silanes of the general formula 1. Any silanol groups formed by hydrolysis that are present in the compounds of the general formula 1 or their oligomers are not troublesome.

In the first step of the process there can also be used tetraalkoxysilanes and/or their hydrolysis/condensation products together with organoalkoxysilanes of the general formula 1 and/or their hydrolysis/condensation products.

R¹, R² can be linear, branched, cyclic, aromatic, saturated or unsaturated. Examples of amino groups in R¹, R² are radicals —NR⁵R⁶, wherein R⁵ and R⁶ can be hydrogen or a C₁-C₈-alkyl, cycloalkyl, aryl, arylalkyl, alkylaryl radical which can be substituted by —OR⁷, wherein R⁷ can be C₁-C₈-alkyl, aryl, arylalkyl, alkylaryl. If R⁵, R⁶ are alkyl radicals, non-adjacent CH₂ units therein can be replaced by groups —O—, —S—, or —NR³—. R⁵ and R⁶ can also represent a ring. R⁵ is preferably hydrogen or an alkyl radical having from 1 to 6 carbon atoms.

R¹, R² in the general formula 1 preferably represents a monovalent hydrocarbon radical having from 1 to 18 carbon atoms which is unsubstituted or substituted by halogen atoms or by amino, alkoxy or silyl groups. Particular preference is given to unsubstituted alkyl radicals, cycloalkyl radicals, alkylaryl radicals, arylalkyl radicals and phenyl radicals. The hydrocarbon radicals R¹, R² preferably have from 1 to 6 carbon atoms. Particular preference is given to the methyl, ethyl, propyl, 3,3,3-trifluoropropyl, vinyl and phenyl radical, and most particular preference is given to the methyl radical.

Further examples of radicals R¹, R² are: n-propyl, 2-propyl, 3-chloropropyl, 2-(trimethylsilyl)ethyl, 2-(trimethoxysilyl)-ethyl, 2-(triethoxysilyl)-ethyl, 2-(dimethoxymethylsilyl)-ethyl, 2-(diethoxymethylsilyl)-ethyl, n-butyl, 2-butyl-, 2-methylpropyl, tert-butyl-, n-pentyl, cyclopentyl, n-hexyl, cyclohexyl, n-heptyl, n-octyl, 2-ethylhexyl, n-nonyl, n-decyl, n-undecyl, 10-undecenyl, n-dodecyl, isotridecyl, n-tetradecyl, n-hexadecyl, vinyl, allyl, benzyl, p-chlorophenyl, o-(phenyl)phenyl, m-(phenyl)phenyl, p-(phenyl)phenyl, 1-naphthyl, 2-naphthyl, 2-phenylethyl, 1-phenylethyl, 3-phenylpropyl, 3-(2-aminoethyl)aminopropyl, 3-aminopropyl, N-morpholinomethyl, N-pyrrolidinomethyl, 3-(N-cyclohexyl)aminopropyl, 1-N-imidazolidinopropyl radical. Further examples of R¹, R² are radicals —(CH₂O)n—R⁸, —(CH₂CH₂O)m—R⁹, and —(CH₂CH₂NH)ₒH, wherein n, m and o represent values from 1 to 10, in particular 1, 2, 3, and R⁸, R⁹ have the meanings of R⁵, R⁶.

R³ preferably represents hydrogen or an alkyl radical having from 1 to 6 carbon atoms which is unsubstituted or substituted by halogen atoms. Examples of R³ are listed above for R¹.

d preferably represents the value 0. d represents a value 1, 2 or 3 in preferably not more than 20 mol %, in particular not more than 5 mol %, of the compounds of the general formula 1.

Examples of compounds of the general formula 1 wherein a=1 are:

MeSi(OMe)₃, MeSi(OEt)₃, MeSi(OMe)₂(OEt), MeSi(OMe)(OEt)₂, MeSi(OCH₂CH₂OCH₃)₃, H₃C—CH₂—CH₂—Si(OMe)₃, (H₃C)₂CH—Si(OMe)₃, CH₃CH₂CH₂CH₂—Si(OMe)₃, (H₃C)₂CHCH₂—Si(OMe)₃, tBu-Si(OMe)₃, PhSi(OMe)₃, PhSi(OEt)₃, F₃C—CH₂—CH₂—Si(OMe)₃, H₂C═CH—Si(OMe)₃, H₂C═CH—Si(OEt)₃, H₂C═CH—CH₂—Si(OMe)₃, Cl—CH₂CH₂CH₂—Si(OMe)₃, cy-Hex-Si (OEt)₃, cy-Hex-CH₂—CH₂—Si(OMe)₃, H₂C═CH—(CH₂)₉—Si(OMe)₃, CH₃CH₂CH₂CH₂CH(CH₂CH₃)—CH₂—Si(OMe)₃, hexadecyl-Si(OMe)₃, Cl—CH₂—Si(OMe)₃, H₂N—(CH₂)₃—Si(OEt)₃, cyHex-NH—(CH₂)₃—Si(OMe)₃, H₂N—(CH₂)₂—NH—(CH₂)₃—Si(OMe)₃, O(CH₂CH₂)₂N—CH₂—Si(OEt)₃, PhNH—CH₂—Si(OMe)₃, hexadecyl-SiH₃, (MeO)₃Si—CH₂CH₂—Si(OMe)₃, (EtO)₃Si—CH₂CH₂—Si(OEt)₃, (MeO)₃SiSi(OMe)₂Me, MeSi (OEt)₂Si(OEt)₃.

Preference is given to MeSi(OMe)₃, MeSi(OEt)₃, (H₃C)₂CHCH₂—Si(OMe)₃ and PhSi(OMe)₃, with methyltrimethoxysilane and its hydrolysis/condensation product being particularly preferred.

Examples of compounds of the general formula 1 wherein a=2 are:

Me₂Si(OMe)₂, Me₂Si(OEt)₂, Me₂Si(OCH(CH₃)₂)₂, MeSi(OMe)₂CH₂CH₂CH₃Et₂Si(OMe)₂, Me₂Si(OCH₂CH₂OCH₃)₂, MeSi(OMe)₂Et, (H₃C)₂CH—Si(OMe)₂Me, Ph-Si(OMe)₂Me, t-Bu-Si(OMe)₂Me, Ph₂Si(OMe)₂, PhMeSi(OEt)₂, MeEtSi(OMe)₂,

F₃C—CH₂—CH₂—Si(OMe)₂Me, H₂C═CH—Si(OMe)₂Me, H₂C═CH—CH₂—Si(OMe)₂Me, Cl—CH₂CH₂CH₂—Si(OMe)₂Me, cy-Hex-Si(OMe)₂Me, cy-Hex-CH₂—CH₂—Si(OMe)₂Me, H₂C═CH—(CH₂)₉—Si(OMe)₂Me, Cl—CH₂—SiMe(OMe)₂, H₂N—(CH₂)₃—SiMe(OEt)₂, cyHex-NH—(CH₂)₃—SiMe(OMe)₂, H₂N—(CH₂)₂—NH—(CH₂)₃—SiMe(OMe)₂, O(CH₂CH₂)₂N—CH₂—SiMe(OMe)₂, PhNH—CH₂—SiMe(OMe)₂, (MeO)₂MeSi—CH₂CH₂—SiMe(OMe)₂, (EtO)₂MeSi—CH₂CH₂—SiMe(OEt)₂, (MeO)₂MeSiSi(OMe)₂Me, MeSi(OEt)₂SiMe(OEt)₂, MeCl₂SiSiMeCl₂, Me₂Si(OMe)Si(OMe)₃, Me₂Si(OMe)Si(OMe)Me₂, Me₂Si(OMe)SiMe₃, Me₂Si(OMe)SiMe(OMe)₂.

Preference is given to Me₂Si(OMe)₂, Me₂Si(OEt)₂, MeSi(OMe)₂CH₂CH₂CH₃ and Ph-Si(OMe)₂Me, with Me₂Si(OMe)₂ and MeSi(OMe)₂CH₂CH₂CH₃ being particularly preferred.

Me denotes methyl radical, Et denotes ethyl radical, Ph denotes phenyl radical, t-Bu denotes 2,2-dimethylpropyl radical, cy-Hex denotes cyclohexyl radical, hexadecyl denotes n-hexadecyl radical.

Preferably a=1 or 2.

In particular, at least 50%, preferably at least 60%, particularly preferably at least 70%, and not more than 100%, preferably not more than 90%, particularly preferably not more than 80%, of all the radicals R¹ in the compounds of the general formula 1 or their hydrolysis/condensation products are methyl radicals, ethyl radicals or propyl radicals.

The alkali metal hydroxide used is preferably selected from lithium, sodium and potassium hydroxide.

The amount of alkali metal hydroxide is preferably so chosen that the molar ratio of cation to silicon is at least 0.2, preferably at least 0.4, particularly preferably at least 0.5, most particularly preferably at least 0.6, and not more than 2.0, preferably not more than 1.0, particularly preferably not more than 0.8, most particularly preferably not more than 0.7.

In addition to solutions, it is also possible to use suspensions in which silanolate salt is present in undissolved form. Mixtures of alcoholic-aqueous mixtures of different silanolate salts can also be dried by the process according to the invention, whereby one or more alcohols can be present.

The purpose of step 2 is to remove as large a proportion of the alcohol as possible from the mixture, optionally with a small portion of the water that is present. Preferably at least 20%, particularly preferably at least 40%, in particular at least 50% of the alcohol present is distilled off. In step 3, residual alcohol and the water that is present or has formed in the drying process, optionally by condensation processes, are removed preferably at the same temperature as in step 2 but under reduced pressure. Drying is preferably carried out to a residual moisture content in the powder (P), when measured at 120° C., of not more than 3 wt. %, particularly preferably not more than 1 wt. %, in particular not more than 0.5 wt. %, based on the original weight. Both steps are preferably carried out with the exclusion of oxygen, in particular under an inert gas atmosphere, for example of nitrogen, argon, helium.

If organoalkoxysilanes of the general formula 1 are used in the first step, the drying or wall temperature, that is to say the highest temperature with which the mixture to be dried comes into contact, is preferably so chosen that thermal decomposition of the reaction mixture is largely avoided within the total drying time in steps 2 and 3. To that end, the time to the maximum rate of thermal decomposition under adiabatic conditions (=Time to Maximum Rate=TMR_{ad}) is conventionally determined at different temperatures by means of DSC measurements on the hydrolyzate mixture, and the maximum temperature is chosen at which, optionally while observing a safety interval, there is no risk of uncontrolled exothermic decomposition within the period of the thermal load during drying. The drying or wall temperature is preferably so chosen that the TMR_{ad} is at least 200%, preferably at least 150%, particularly preferably at least 100%, of the drying time. This gives the maximum obtainable amount of distillate in step 2: a larger amount of distillate is obtained at higher temperatures than at lower temperatures. In order to achieve a high space-time yield, as high a temperature as possible in step 2 is therefore to be sought. The drying or wall temperature in step 2 and 3 is preferably at least 70° C., particularly preferably at least 90° C., in particular at least 100° C., and preferably not more than 200° C., particularly preferably not more than 160° C., in particular not more than 140° C., provided that no disruptive thermal decomposition occurs at those temperatures. The temperature can remain constant during step 2 or can follow an ascending or descending gradient, an ascending gradient being preferred.

The degree of drying that can be achieved in step 3 is determined by the drying or wall temperature, the pressure and the duration. The drying or wall temperature is preferably within the range mentioned for step 2. However, it can be higher or lower or can follow an ascending or descending gradient. The pressure in step 3 is chosen to be as low as possible in order to keep the duration of the drying as short as possible and thus maximize the space-time yield. It is preferably not more than 200 hPa, more preferably not more than 100 hPa, particularly preferably not more than 50 hPa, in particular not more than 20 hPa. Step 2 is generally carried out under a higher pressure than step 3, preferably at least 500 hPa above the pressure of step 3, particularly preferably at least 700 hPa above the pressure of step 3, in particular under the pressure that is established by the inert gas blanketing of the apparatus, that is to say excess pressure of not more than 5 hPa relative to atmospheric pressure. If steps 2 and 3 are carried out in succession in a single apparatus, for example a batch reactor such as a stirring unit or paddle drier, then the pressure is preferably not reduced suddenly during the transition from step 2 to step 3, in order to avoid boiling retardation and possible foaming over, but as quickly as possible. If steps 2 and 3 are each carried out in a separate apparatus, then the transition from one apparatus to the other can be accompanied by a pressure jump. In that case, in order to accelerate the evaporation process, relaxation into the apparatus for step 3 can take place via a nozzle, so that a larger surface is obtained owing to the fine atomization of the product from step 2, so-called flash evaporation.

It is also possible for a pressure gradient to be followed from the beginning of drying in step 2 to the end of drying in step 3. This procedure is recommended, for example, for an automated time-optimized batch process. Furthermore, the at least temporary passage of a gas, for example inert gas such as nitrogen, or vapor, for example steam, constitutes an additional possible method of accelerating the drying process both in step 2 and in step 3.

The process can be carried out in batch mode, for example using a stirred tank or paddle drier with a distillation head, as is conventional in multipurpose installations. In contrast to direct heating, for example by means of electrical resistance heating, induction heating, microwave heating, firing/hot gas heating, it is more advantageous in the case of indirect heat transfer by means of heat transfer media, for example steam, water, heat transfer oil, from the point of view of the process and for time reasons, if steps 2 and 3 proceed at the same temperature.

Owing to the low level of fouling, it is not usually necessary during production campaigns to clean the reactor of solids residues between the individual batches. If cleaning should nevertheless be required, for example at the end of the campaign, it is readily possible, inexpensively and without harmful emissions, simply by rinsing or optionally flushing the installation with water. A continuous process in a tubular reactor or a mixing/conveying unit such as a kneader or a single-screw or twin-screw extruder or a horizontal paddle drier—preferably having a plurality of chambers for the various process steps—is likewise possible and is advantageous for large-scale production.

In order to avoid the formation of foam, an antifoam, for example a silicone oil, a surfactant or a defoaming agent mixture of highly dispersed silica and silicone oil, is preferably added in step 2, in particular in the pressure reduction in step 3. The addition of defoaming additive is preferably not more than 3 wt. %, particularly preferably not more than 1 wt. %, in particular not more than 0.5 wt. %, based on the starting mixture used in step 2.

In addition, further additives such as, for example, flow-regulating agents, anticaking agents can be added before, during or after the process according to the invention.

If desired, the solids obtained by the process according to the invention can be comminuted or compressed to form coarser particles or shaped bodies, for example granules, briquettes, and then screened and graded.

All the above symbols of the above formulae have their meanings in each case independently of one another. In all formulae, the silicon atom is tetravalent.

In the examples and comparative examples which follow, all amounts and percentages are based on weight, unless indicated otherwise, and all reactions are carried out at a pressure of 1000 hPa (abs.).

### Example 1

### Three-Step Process According to the Invention for Drying a Potassium Methyl Siliconate (K:Si=0.65:1)

In step 1, a hydrolyzate H1 is prepared analogously to Example 1 of DE 4336600 from one molar equivalent of methyltrimethoxysilane (prepared from 1 molar equivalent of methyltrichlorosilane and 2*1.5 molar equivalents of methanol), 0.65 molar equivalent of potassium hydroxide and 3.5 molar equivalents of water (in the form of a 37% potassium hydroxide solution).

Solids content=42 wt. % (determined at 160° C. using a solids content balance HR73 Halogen Moisture Analyzer from Mettler Toledo, contains according to NMR 44.5 wt. % methanol and 13.5 wt. % water).

In order to determine the variation in the thermal stability during the drying process, a sample of that mixture is devolatilized in succession at 120° C. first under normal pressure and then with a pressure reduction to 5 hPa. Samples for DSC measurements are taken at various stages of the process. According to those measurements, the moist but already solid distillation residue has the lowest onset temperature (about 174° C.) and the highest decomposition energy (about 806 kJ/kg).

In order to determine the Time to Maximum Rate (TMR_{ad}) of the thermal decomposition under adiabatic conditions, DSC measurements of that residue are carried out with different heating rates in pressure-resistant stainless steel crucibles under nitrogen in a temperature range between room temperature and 400° C. Evaluation is made by a so-called “isoconversion” method with conversion-dependent activation energy according to S. Vyzovkin, C. A. Wright, Model-free and model-fitting approaches to kinetic analysis of isothermal and nonisothermal Data, Thermochim. Acta, 1999, 340-341, 53-68. The evaluation is carried out using the program AKTS, Thermal Kinetics, Version 3.24 according to B. Roduit, Ch. Borgeat, B. Berger, P. Folly, B. Alonso, J. N. Aebischer, F. Stoessel, Advanced Kinetic Tools for the Evaluation of Decomposition Reactions, J. Thermal Anal. and Calor. 2005, 80, 229-236. The TMR_{ad} is calculated for different temperatures using the conversion-dependent activation energy.

There is accordingly obtained a TMR_{ad} of >24 h at 118° C., of >20 h at 120° C. and of >8 h at 130° C.

On the basis of these data, a wall temperature of not more than 120° C. is established for the drying process.

### Drying of a Potassium Methyl Siliconate Solution

400 g of the hydrolyzate H1 are placed in a 2-liter double-jacket glass laboratory reactor which has been inertized with nitrogen and has a blade agitator, a thermometer and a distillation bridge, and 0.12 g of silicone oil AK 100 (available commercially from WACKER CHEMIE AG) is added as defoaming additive.

Step 2: The agitator is set to 230 rpm, and the heat transfer oil adjusted to a temperature of 120° C. by means of a thermostat is admitted into the reactor jacket. The reactor contents heat up and begin to boil at 71° C., the boiling temperature rises to 77° C. during the removal of distillate, and then the mass flow of distillate falls. A total of 89.2 g of clear, colorless condensate is collected within a period of 20 minutes, which condensate, according to gas chromatography analysis, contains 93.8 wt. % methanol and 6.2 wt. % water. This corresponds to about 47% of the total amount of methanol and about 10% of the total amount of water.

Step 3: At a jacket temperature of 120° C., the pressure is gradually reduced to 5 hPa by means of a vacuum pump, whereby volatile constituents are condensed. The viscous, cloudy distillation residue from step 1 is visibly converted into a foamy-white viscous mass and finally changes into a fine dry powder.

144.4 g of clear colorless distillate collect in the receiver within a period of 30 minutes, which distillate, according to gas chromatographic analysis, contains 67.6% methanol and 32.4% water. This corresponds to about 55% of the total amount of methanol and about 87% of the total amount of water. After drying for one hour at 120° C./5 hPa, 167.9 g of fine, white, pourable powder are obtained, the solids content of which is 99.4% (determined at 160° C. using a solids content balance HR73 Halogen Moisture Analyzer from Mettler Toledo) and which dissolves to the extent of 50% in water.

In total, 99.3% of the amount of solids used, the whole amount of methanol and about 97% of the amount of water are isolated.

### Example 2

### Three-Step Process According to the Invention for Drying a Potassium Isobutyl Siliconate (K:Si=1:1)

### a) Preparation of a Potassium Isobutyl Siliconate Solution, Step 1

100 g of methanol are placed in a 2-liter double-jacket glass laboratory reactor which has been inertized with nitrogen and has a blade agitator, a dropping funnel, a thermometer and a distillation bridge, and heated to 50° C. 737 g of isobutyltrimethoxysilane (97%, available commercially from Alfa-Aesar) and 500 g of 45% potassium hydroxide solution are metered in in parallel within a period of one hour. Heating is carried out for 30 minutes at reflux (75° C.) and then the amount of methanol which was placed in the reactor is distilled off. There remain as residue 1222.4 g of a clear colorless liquid, the solids content of which is 57.9% (determined at 160° C. using a solids content balance HR73 Halogen Moisture Analyzer from Mettler Toledo). By calculation this gives a methanol content of 31.3 wt. % and a water content of 10.8 wt. %.

### b) Drying of the Potassium Isobutyl Siliconate Solution

40 g of the potassium isobutyl siliconate solution from a) are placed in a 250-ml four-necked round-bottomed flask which has been inertized with nitrogen and has a blade agitator, a dropping funnel, a thermometer and a distillation bridge. Step 2: The agitator is set at 230 rpm and the heat transfer oil adjusted to a temperature of 120° C. is admitted into the reactor jacket. The reactor contents heat up and begin to boil at 82° C., the mass flow of distillate falls after 10 minutes. Step 3: At a jacket temperature of 120° C., the pressure is reduced to 5 hPa within a period of 30 minutes by means of a vacuum pump, whereupon volatile constituents are condensed. The jelly-like distillation residue from step 2 is visibly converted into individual brittle particles and finally changes into a fine dry powder. After a further 30 minutes at an oil bath temperature of 120° C. and 5 hPa, 21.7 g of fine, white, pourable powder are obtained, the solids content of which is 99.2% (determined at 160° C. using a solids content balance HR73 Halogen Moisture Analyzer from Mettler Toledo). A total of 17.4 g of clear colorless distillate collect in the receiver, which distillate, according to gas chromatographic analysis, contains 74.2 wt. % methanol and 25.8 wt. % water. In total, about 94% of the amount of solids used, the whole of the amount of methanol and about 96% of the amount of water are isolated.

### Comparative Example 1 Not According to the Invention

### Drying of an Aqueous/Methanolic Solution of a Potassium Methyl Siliconate (K:Si=0.65:1) 120° C./Vacuum

It is shown that, in the case of more rapid removal of the volatile constituents—that is to say a process that per se is more economical—agglomeration of the solid (“dumpling formation”) occurs, which makes the drying operation considerably more difficult.

120 g of hydrolyzate H1 according to Example 1 and 0.04 g of silicone oil AK 100 (available commercially from WACKER CHEMIE AG) as defoaming additive are placed in a 500-ml three-necked flask having a blade agitator, a thermometer and a distillation bridge with receiver. The flask is heated by an oil bath adjusted to a temperature of 120° C. Reflux occurs at 71° C. By means of a vacuum pump, the pressure is reduced in such a manner that the temperature of the mixture can be maintained between 50° C. and 60° C. Condensate collects in the receiver and in the cold trap cooled with liquid nitrogen. After 16 minutes, 220 hPa has been reached, the mixture, cooled to 50° C., begins to foam, at the same time a tacky wall covering forms, which visibly agglomerates to form a large clump which decomposes into smaller pieces only when broken up with a spatula. After one hour at 5 hPa and an oil bath temperature of 120° C. there are obtained 49.1 g of white granular particles, the solids content of which is 99.8% (determined at 160° C. using a solids content balance HR73 Halogen Moisture Analyzer from Mettler Toledo).

In total, 97.4% of the amount of solid used are isolated. 68.3 g of clear colorless distillate collect in the receiver and cold trap, which distillate, according to gas chromatography analysis, contains 74.2 wt. % methanol and 25.7 wt. % water. This corresponds to the total amount of methanol and 98% of the total amount of water.

### Comparative Example 2 Not According to the Invention

### Drying of an Aqueous/Methanolic Solution of a Potassium Methyl Siliconate (K:Si=0.65:1) 50° C.-120° C./Vacuum

It is shown that more gentle conditions yield tacky end products with an undesirably high methanol content.

120 g of hydrolyzate, prepared analogously to Example 1 of DE 4336600 from one molar equivalent of methyltrimethoxysilane (prepared from 1 molar equivalent of methyltrichlorosilane and 2*1.5 molar equivalents of methanol), 0.65 molar equivalent of potassium hydroxide and 3.5 molar equivalents of water (in the form of a 37% potassium hydroxide solution), solids content=44.3 wt. % (determined at 160° C. using a solids content balance HR73 Halogen Moisture Analyzer from Mettler Toledo, contains 42.3 wt. % methanol and 13.4 wt. % water according to NMR) and 0.04 g of silicone oil AK 100 (available commercially from WACKER CHEMIE AG) as defoaming additive are placed in a 500-ml three-necked flask having a blade agitator, a thermometer and a distillation bridge with receiver. The flask is heated by an oil bath adjusted to a temperature of 50° C. The pressure is reduced to 5 hPa by means of a vacuum pump. The temperature of the mixture falls rapidly to −1° C. Condensate collects in the cold trap cooled with liquid nitrogen. The oil bath temperature is raised slowly at constant pressure. After 7 minutes, an oil bath temperature of 60° C. has been reached, and the internal temperature is 5° C. Solid wall coatings are precipitated from the viscous bottom product. After a further 10 minutes, the oil bath has a temperature of 70° C. and the internal temperature is 10° C. The viscous mass winds itself around the stirrer.

Stirring is continued for one hour at an oil bath temperature of 120° C. and 5 hPa, and 57 g of a white, tacky, compact solid are obtained only after complex mechanical division with a spatula; the solids content of the solid is 91.9% (determined at 160° C. using a solids content balance HR73 Halogen Moisture Analyzer from Mettler Toledo).

60.6 g of clear colorless distillate collect in the receiver and cold trap, which distillate, according to gas chromatography analysis, contains 73.4 wt. % methanol and 26.5 wt. % water. This corresponds to 88% of the amount of methanol and the total amount of water. 107% of the amount of solid used are isolated. This means that an amount of about 8 wt. % methanol must have remained in the solid; residual methanol that has not been isolated is obviously not condensed and disappears via the waste gas path.

### Comparative Example 3 Not According to the Invention

### Drying of an Aqueous/Methanolic Solution of a Potassium Methyl Siliconate (K:Si=0.65:1) 70° C./Vacuum

It is shown that more gentle conditions yield tacky end products having an undesirably high methanol content.

120 g of hydrolyzate H1, prepared analogously to Example 1 and 0.04 g of silicone oil AK 100 (available commercially from WACKER CHEMIE AG) as defoaming additive are placed in a 500-ml three-necked flask having a blade agitator, a thermometer and a distillation bridge with receiver. The flask is heated by an oil bath adjusted to a temperature of 70° C. By means of a vacuum pump, the pressure is reduced to 5 hPa in such a manner that the temperature of the mixture is between 50 and 60° C. Condensate collects in the receiver and in the cold trap cooled with liquid nitrogen. At 200 hPa, the contents begin to foam vigorously and a wall coating forms. At 50 hPa, the tacky-viscous residue winds itself around the stirrer shaft. Stirring is continued for one hour at an oil bath temperature of 120° C. and 5 hPa, and 56.7 g of a white, tacky, granular solid are obtained only after complex mechanical division with a spatula; the solids content of the solid is 88.6% (determined at 160° C. using a solids content balance HR73 Halogen Moisture Analyzer from Mettler Toledo).

60.6 g of clear colorless distillate collect in the receiver and cold trap, which distillate, according to gas chromatography analysis, contains 75 wt. % methanol and 24.9 wt. % water. This corresponds to about 90% of the amount of methanol and about 94% of the amount of water. 107% of the amount of solid used are isolated. This means that, in addition to about 2 wt. % water, an amount of about 9 wt. % methanol must have remained in the solid.

1.-9. (canceled)

10. A process for producing powders (P) from salts of silanols, of their hydrolysis/condensation products, or of silanols together with their hydrolysis/condensation products, and alkali metal ions cations in which the molar ratio of cation to silicon is from 0.1 to 3, comprising:
in a first step, hydrolyzing alkoxysilanes, their hydrolysis/condensation products, or alkoxysilanes together with their hydrolysis/condensation products, wherein the alkoxy group is selected from methoxy, ethoxy, 1-propoxy and 2-propoxy groups, with alkali metal hydroxide and water,
in a second step, distilling at least a total of 20 percent by weight of water and alcohol present in the hydrolyzate from the hydrolyzate prepared in the first step, and
in a third step, removing residual water and alcohol at a lower pressure than in the second step.

11. The process of claim 10, wherein salts of organosilanols are prepared, wherein in the first step organoalkoxysilanes of the general formula 1
(R¹)ₐSi(OR⁴)_{b}(—Si(R²)_{3-c}(OR⁴)_{c})_{d} (1)
or their hydrolysis/condensation products, or the organosilanes of the general formula 1 together with their hydrolysis/condensation products are used,
wherein
R¹ and R² are monovalent Si—C-bonded hydrocarbon radicals having from 1 to 30 carbon atoms which is unsubstituted or substituted by halogen atoms, amino groups, C₁₋₆-alkyl or C₁₋₆-alkoxy or silyl groups and in which one or more non-adjacent —CH₂— units are optionally replaced by groups —O—, —S—, or —NR³— and in which one or more non-adjacent ═CH— units are optionally replaced by groups —N═,
R³ is hydrogen, or a monovalent hydrocarbon radical having from 1 to 8 carbon atoms which is unsubstituted or substituted by halogen atoms or NH₂ groups,
R⁴ is a methoxy, ethoxy, 1-propoxy or 2-propoxy group,
a is 1, 2 or 3, and
b, c, d are 0, 1, 2 or 3,
with the proviso that b+c≧1 and a+b+d=4.

12. The process of claim 11, wherein R¹ and R² are alkyl radicals having from 1 to 6 carbon atoms.

13. The process of claim 10, wherein the alkali metal hydroxide used is sodium hydroxide and/or potassium hydroxide.

14. The process of claim 11, wherein the alkali metal hydroxide used is sodium hydroxide and/or potassium hydroxide.

15. The process of claim 10, wherein in the second step at least 40% of the alcohol present is distilled off.

16. The process of claim 11, wherein in the second step at least 40% of the alcohol present is distilled off.

17. The process of claim 10, wherein in the third step residual alcohol and water are removed at the same temperature as in the second step.

18. The process of claim 10, wherein the pressure in the third step is not more than 200 hPa.

19. The process of claim 10, wherein the pressure in the second step is at least 500 hPa above the pressure of the third step.

20. The process of claim 10, wherein an antifoam is present in the second step.
